(19) United States
(12) Patent Application Publication
(10) Pub. No.: US 2009/0243949 A1
(43) Pub. Date: Oct. 1, 2009

(54) COMMUNICATION MODULE AND ELECTRONIC APPARATUS

(75) Inventors: Minoru TAKIZAWA, Sagamihara-shi (JP); Ryoji NINOMIYA, Tachikawa-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/371,875

(22) Filed: Feb. 16, 2009

(30) Foreign Application Priority Data
Mar. 27, 2008 (JP) 2008-083849

(51) Int. Cl. H01Q 3/02; H01Q 1/36

(52) U.S. Cl. 343/757; 343/700 MS

(57) ABSTRACT

According to an aspect of the present invention, there is provided a communication module including: a substrate including a recess, the recess including a bottom face and an opening portion; a MEMS device including a directional antenna, the MEMS device disposed in the recess and including a planar portion; and a supporting section configured to support the MEMS device so that an angle between the planar portion and the bottom face is changeable, the supporting section configured to electrically connect the substrate to the directional antenna.

### CROSS-REFERENCE TO RELATED APPLICATIONS

This application is based upon and claims the benefit of priority from Japanese Patent Application No. 2008-083849, filed on Mar. 27, 2008, the entire contents of which are incorporated herein by reference.

### BACKGROUND

1. Field

An aspect of the present invention relates to a communication module and an electronic apparatus using a directional antenna.

2. Description of the Related Art

Conventionally, as the technique of making variable a direction of a directionality of an antenna, there are techniques disclosed in JP-A-9-83240 and JP-A-2007-266818.

A communication module disclosed in JP-A-9-83240 includes a multi-layered antenna, and is configured so that an antenna layer which is a part of the multi-layered antenna is disposed with being separated from the remaining antenna layer, and relative positions of the antenna layers are made variable, whereby the direction of the directionality of the antenna can be made variable.

An antenna device disclosed in JP-A-2007-266818 includes: a planar antenna element; a holding portion swingably holds the planar antenna element through at least 90 degrees about a parallel axis which is parallel to the plane; and a base portion which swingably holds the planar antenna element through 360 degrees about a perpendicular direction axis that is not parallel to the plane, and that is perpendicular to the parallel axis, whereby the direction of the directionality of the antenna is made variable in all directions of a hemisphere face on the plane.

On the other hand, a communication module using a directional antenna of this kind is used in a portable electronic apparatus such as a portable telephone or a notebook personal computer. Recently, a portable electronic apparatus having a smaller size is being developed. Also a communication module which is used in such a small electronic apparatus is required to be disposed so as to maintain the whole size of the electronic apparatus to be small.

In the related art, however, a large space is required in order to make variable the direction of the directionality of an antenna, and hence it is difficult to sufficiently reduce the size of a communication module. When a communication module to which the related art is applied is used on an electronic apparatus, therefore, a large mounting area is necessary.

### BRIEF DESCRIPTION OF THE SEVERAL VIEWS OF THE DRAWINGS

A general architecture that implements the various feature of the present invention will now be described with reference to the drawings. The drawings and the associated descriptions are provided to illustrate embodiments of the present invention and not to limit the scope of the present invention.

FIG. 1 is an exemplary schematic external view showing an embodiment of an electronic apparatus of the invention;

FIG. 2 is a sectional view showing an example of a communication module;

FIG. 3 is a plan view showing a configuration example of a silicon wafer, a planar antenna, and an axis member in the communication module shown in FIG. 2;

FIG. 4 is a sectional view taken along line IV-IV of FIG. 3;

FIG. 5 is a sectional view taken along line V-V of FIG. 3;

FIG. 6 is a sectional view showing an example of the case where, in the communication module shown in FIG. 5, the axis member includes an electrostatic micromotor implemented as a MEMS device;

FIG. 7 is a plan view of the communication module showing an example of the case where a piezoelectric actuator implemented as a MEMS device is used as supporting section;

FIG. 8 is a sectional view of the communication module showing an example of the case where a variable-shape member implemented as a MEMS device is used as the supporting section;

FIG. 9 is an exemplary view illustrating a case where a millimeter wave communication controlling portion is disposed on a module circuit board shown in FIG. 1;

FIG. 10 is a view illustrating an example of a case where the communication module is disposed on a system circuit board shown in FIG. 1;

FIG. 11 is a view illustrating another example of the case where the communication module is disposed on the system circuit board shown in FIG. 1;

FIG. 12 is a plan view of the communication module showing the case where the communication module is provided with a plurality of planar antennas; and

FIG. 13 is a sectional view taken along line XIII-XIII of FIG. 12.

### DETAILED DESCRIPTION

Various embodiments according to the present invention will be described hereinafter with reference to the accompanying drawings. In general, according to one embodiment of the present invention, a communication module including: a substrate including a recess, the recess including a bottom face and an opening portion; a MEMS device including a directional antenna, the MEMS device disposed in the recess and including a planar portion; and a supporting section configured to support the MEMS device so that an angle between the planar portion and the bottom face is changeable, the supporting section configured to electrically connect the substrate to the directional antenna.

Embodiments of a communication module and an electronic apparatus of the invention will be described with reference to the accompanying drawings. In the following description, a notebook personal computer in which a millimeter wave communication circuit is incorporated will be described as an example of the electronic apparatus.

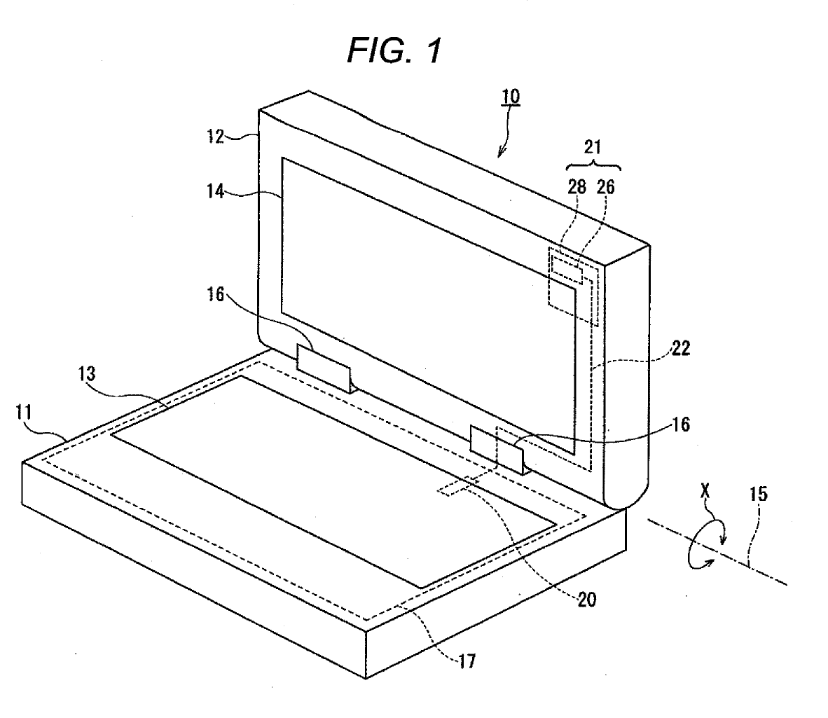

FIG. 1 is a schematic external view showing an embodiment of an electronic apparatus 10 of the invention.

The electronic apparatus 10 includes: a computer body which is covered by a first casing 11; and a display unit which is covered by a second casing 12.

The computer body has a keyboard 13 which is an input unit, in a middle portion of the upper face of the first casing 11. The display unit has an LCD 14 which is a displaying portion. The display unit is coupled to the computer body via a coupling portion 16 (hinge) so as to be openable and closable in directions of the arrow X about an opening/closing shaft 15.

As shown in FIG. 1, a millimeter wave communication controlling portion 20 which serves as a controlling section is disposed inside the first casing 11. The millimeter wave communication controlling portion 20 controls the operation of a communication module 21. The millimeter wave communication controlling portion 20 has a millimeter wave communication circuit which is configured so as to be able to perform millimeter wave communication. The millimeter wave communication circuit is controlled by a CPU disposed on a system circuit board 17 to perform millimeter wave communication.

As shown in FIG. 1, the communication module 21 is disposed inside the second casing 12. The communication module 21 is connected to the millimeter wave communication controlling portion 20 through a coaxial cable 22.

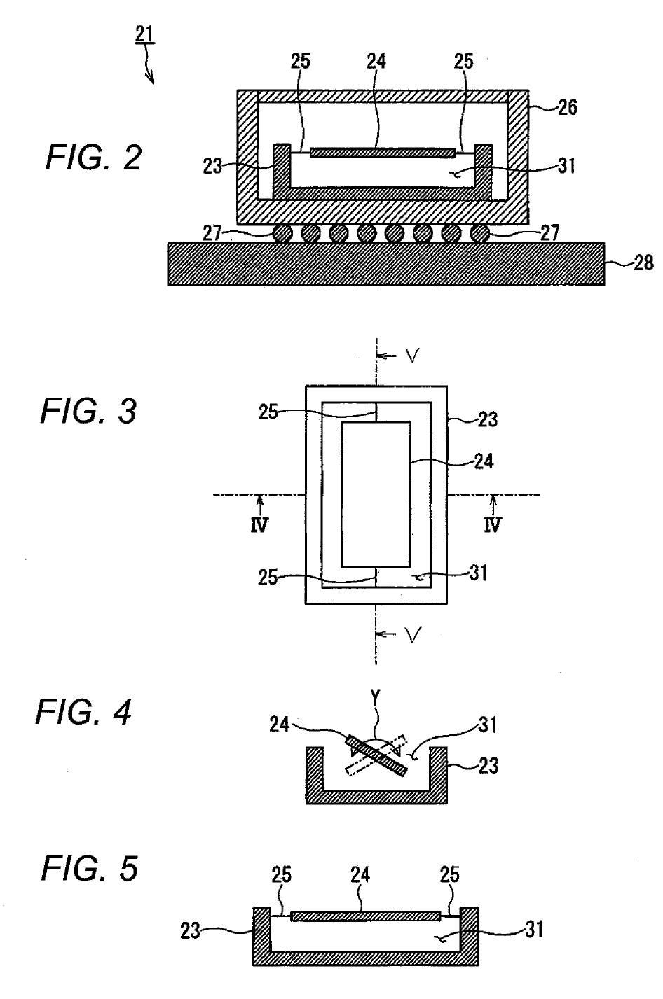

FIG. 2 is a sectional view showing an example of the communication module 21. FIG. 2 shows a casing where a plane of a planar antenna 24 is parallel to a face of a silicon wafer 23.

As shown in FIG. 2, the communication module 21 has the silicon wafer 23 which serves as a substrate, the planar antenna 24, and an axis member 25 which serves as a supporting section.

As shown in FIG. 2, the communication module 21 further has: a casing 26 which covers the silicon wafer 23, the planar antenna 24, and the axis member 25; a plurality of external connecting terminals 27 which are disposed on the outside face of the bottom portion of the casing 26; and a module circuit board 28 on which the casing 26 is mounted through the external connecting terminals 27.

The casing 26 has a box-like shape having a lid, and is configured so that the lid is detachable as required. The lid can prevent disadvantages such as a failure of the planar antenna 24 due to ingress of a foreign material, from occurring.

The external connecting terminals 27 constitute a Ball Grid Array (BGA) which is electrically connected as required to desired places of the silicon wafer 23. The external connecting terminals 27 are electrically connected at least to the planar antenna 24 so that an output signal of the planar antenna 24 can be obtained.

The module circuit board 28 is connected to the coaxial cable 22. The module circuit board 28 is electrically connected to the planar antenna 24 through the external connecting terminals 27. In the embodiment, therefore, the coaxial cable 22 is electrically connected to the planar antenna 24 through the module circuit board 28.

FIG. 3 is a plan view showing a configuration example of the silicon wafer 23, the planar antenna 24, and the axis member 25 in the communication module 21 shown in FIG. 2, FIG. 4 is a sectional view taken along line IV-IV of FIG. 3, and FIG. 5 is a sectional view taken along line V-V of FIG. 3.

As shown in FIGS. 3 to 5, a recess 31 is formed in the silicon wafer 23.

The planar antenna 24 is a millimeter wave receiving device which is formed by Micro Electro Mechanical Systems (MEMS), and which has a planar portion. The planar antenna has a directionality in which a direction perpendicular to one plane of the planar portion is set as the direction of the directionality. The area of the plane is smaller than the opening area of the recess 31, and at least a part of the planar antenna 24 is received in the recess 31 of the silicon wafer 23. The planar antenna 24 is coupled to the silicon wafer 23 through the axis member 25 so as to be swingable about a swing axis in the directions of an arrow Y of FIG. 4.

As shown in FIGS. 3 to 5, the axis member 25 is disposed on the silicon wafer 23, supports the planar antenna 24 so as to make variable the angle of the plane of the planar antenna 24 to a face of the silicon wafer 23 (for example, the bottom face of the recess 31), and electrically connects the silicon wafer 23 to the planar antenna 24.

The planar antenna 24 is supported in such a manner that, when the axis member 25 is swung in the directions of the arrow Y of FIG. 4, the antenna is swung in conjunction with the swinging. When the axis member 25 is swung about the swing axis, therefore, the planar antenna 24 can be swung, and the direction of the directionality of the planar antenna 24 can be made variable.

As a mechanism in which the direction of the directionality of the planar antenna 24 is changed by a supporting member, various mechanisms may be employed. In order to change dynamically and adaptively the direction of the directionality of the planar antenna 24, the supporting section is preferably provided with a driving unit such as an actuator. A driving unit which causes the small planar antenna 24 to operate highly accurately can be suitably implemented as a MEMS device or the like.

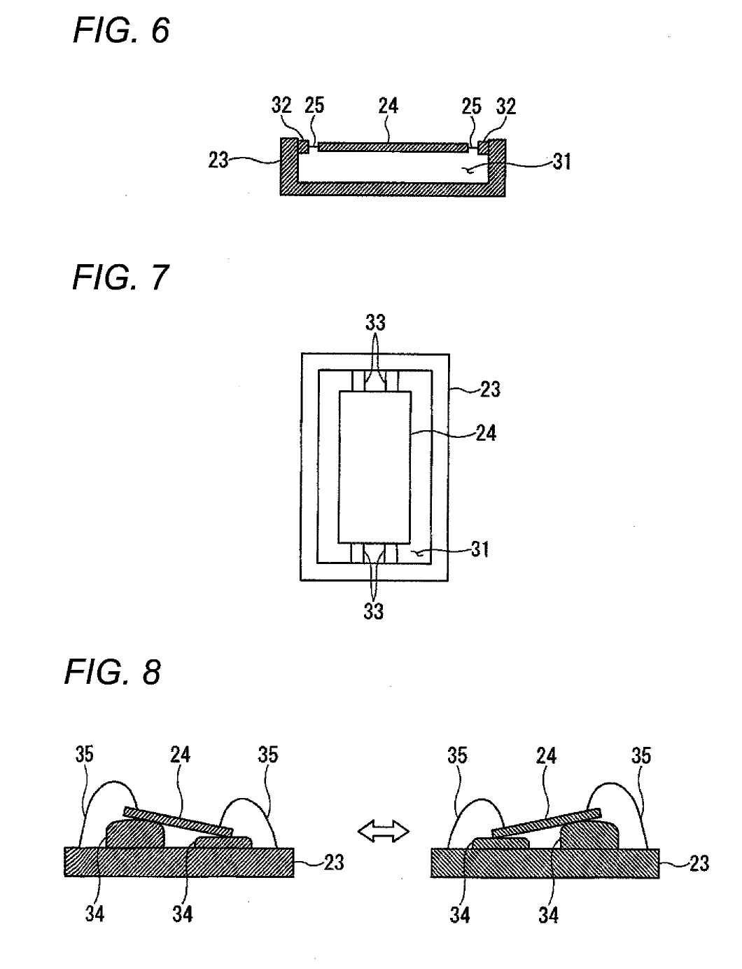

FIG. 6 is a sectional view showing an example of the casing where, in the communication module 21 shown in FIG. 5, the axis member 25 includes an electrostatic micromotor 32 implemented as a MEMS device.

The millimeter wave communication controlling portion 20 applies a predetermined power to the electrostatic micromotor 32 at a predetermined timing, to control the electrostatic micromotor 32 so as to orient the planar antenna 24 to the given direction of the directionality.

An example of the control method is as follows. The level of a radio signal received by the planar antenna 24 is detected by the millimeter wave communication circuit. Based on the detected signal level, the electrostatic micromotor 32 is controlled to change the direction of the directionality of the planar antenna 24. The direction in which the signal level within the movable range of the planar antenna 24 is maximum is detected. According to the method, the direction of the directionality of the planar antenna 24 can be always oriented to the direction in which the transmitting/receiving situation is optimum, and hence the communication environment of the electronic apparatus 10 can be always kept optimum.

Alternatively, when the radio wave detected by the millimeter wave communication circuit is weaker than a predetermined level, the millimeter wave communication controlling portion 20 may perform the above-described control, and, when the direction in which the signal level is maximum within the movable range of the planar antenna 24 is detected, control the electrostatic micromotor 32 so as to stop the swinging of the planar antenna 24.

FIG. 7 is a plan view of the communication module 21 showing an example of the case where a piezoelectric actuator 33 implemented as a MEMS device is used as the supporting section.

As shown in FIG. 7, the supporting section is not required to be the axis member 25, and may be configured by, for example, the piezoelectric actuator 33.

When the supporting section is configured by the piezoelectric actuator 33, the millimeter wave communication controlling portion 20 applies a DC voltage to the piezoelectric actuator 33 to control the deformation amount of the actuator, thereby changing the direction of the directionality of the planar antenna 24.

FIG. 8 is a sectional view of the communication module 21 showing an example of the case where a variable-shape member 34 implemented as a MEMS device is used as the supporting section.

When the variable-shape member 34 implemented as a MEMS device is used as the supporting section, it is not necessary to form the recess 31 in the silicon wafer 23, and the planar antenna 24 may not be implemented as a MEMS device.

As shown in FIG. 8, the variable-shape member 34 is disposed on the silicon wafer 23, and controlled by the millimeter wave communication controlling portion 20 to change the shape. The planar antenna 24 is held by the variable-shape member 34, and the direction of the directionality is changed in accordance with the shape change of the variable-shape member 34.

In order to obtain the output signal of the planar antenna 24, one ends of a pair of conductive bonding wires 35 are connected to the planar antenna 24. The other ends of the bonding wires 35 are connected to the substrate. Therefore, the planar antenna 24 can be electrically connected to the millimeter wave communication circuit of the millimeter wave communication controlling portion 20 through the bonding wires 35, the substrate, and the external connecting terminals 27.

The planar antenna 24 can be held to the variable-shape member 34 by bonding the antenna to the variable-shape member 34 by, for example, using an adhesive material. When an adhesive material is used, when a conductive adhesive material is used as the adhesive material, the planar antenna 24 can be grounded more stably.

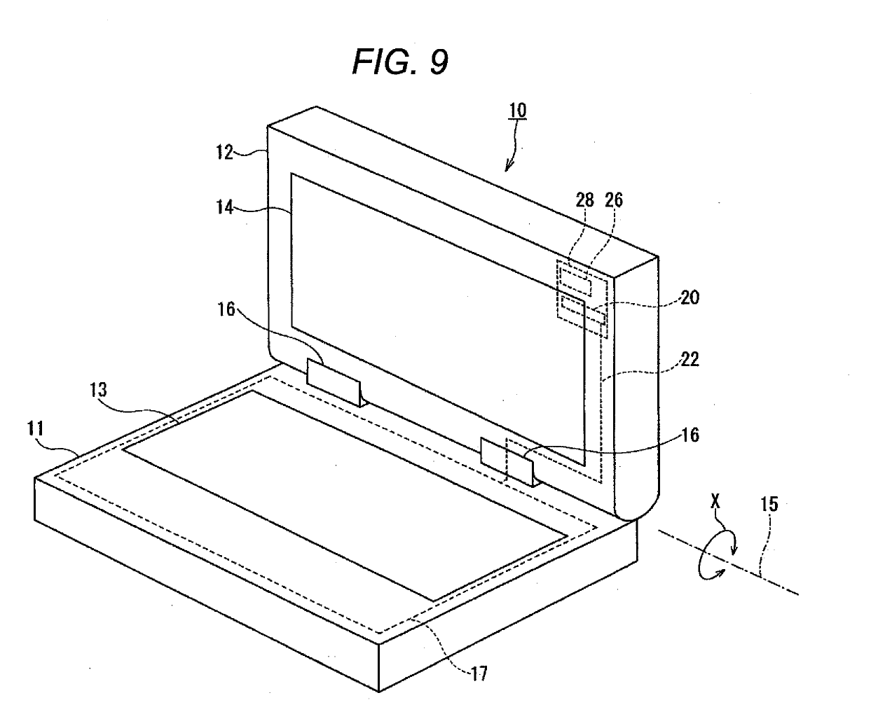

Then, an example in which the positions of the communication module 21 and the millimeter wave communication controlling portion 20 are modified will be described with reference to FIGS. 9 to 11.

FIG. 9 is a view illustrating a case where the millimeter wave communication controlling portion 20 is disposed on the module circuit board 28 shown in FIG. 1.

When the millimeter wave communication controlling portion 20 is disposed on the module circuit board 28 as shown in FIG. 9, it is possible to suppress a signal loss caused by the coaxial cable 22 as far as possible. In this case, the millimeter wave communication circuit of the millimeter wave communication controlling portion 20 is controlled through wirings by the CPU on the system circuit board 17.

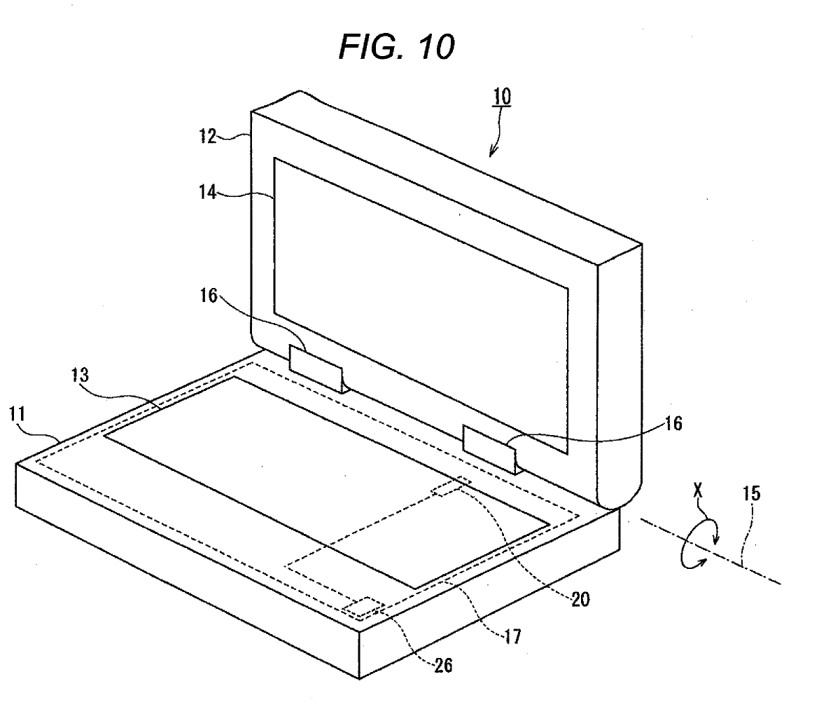

FIG. 10 is a view illustrating an example of a case where the communication module 21 is disposed on the system circuit board 17 shown in FIG. 1.

As shown in FIG. 10, the communication module 21 may be disposed on the system circuit board 17. In this case, the communication module 21 may not be provided with the module circuit board 28.

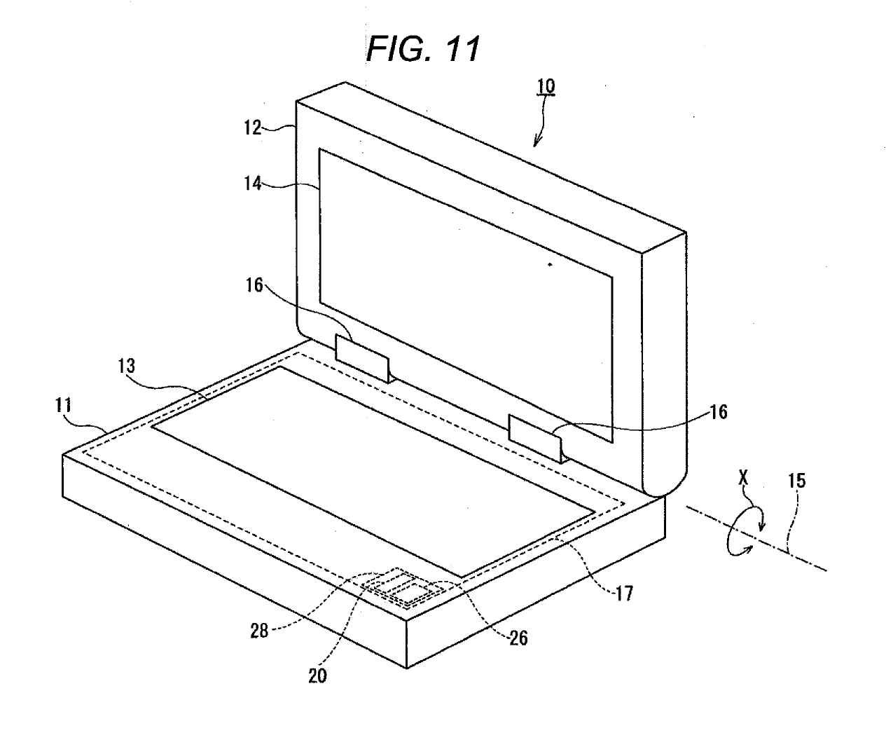

FIG. 11 is a view illustrating another example of the case where the communication module 21 is disposed on the system circuit board 17 shown in FIG. 1.

When the communication module 21 is disposed on the system circuit board 17 as shown in FIG. 11, the millimeter wave communication controlling portion 20 may be disposed on the module circuit board 28 as shown in FIG. 9, so that a signal loss caused by the coaxial cable 22 is suppressed as far as possible. When the communication module 21 is not provided with the module circuit board 28, it is preferable to dispose the communication module 21 and the millimeter wave communication controlling portion 20 on the system circuit board 17 so as to be adjacent to each other.

Then, an example of a case where the communication module 21 is provided with a plurality of planar antennas 24 will be described.

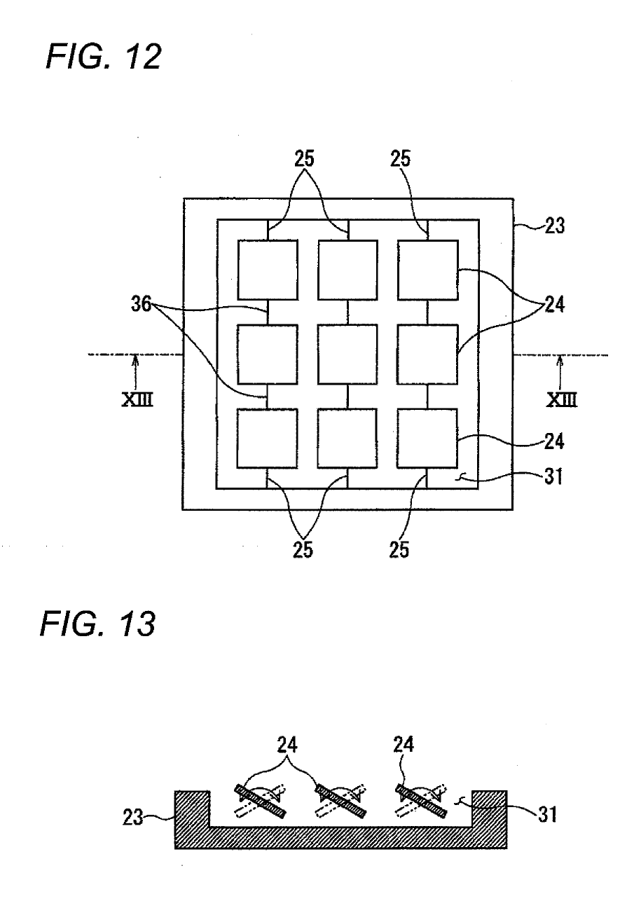

FIG. 12 is a plan view of the communication module 21 showing the case where the communication module 21 is provided with a plurality of planar antennas 24, and FIG. 13 is a sectional view taken along line XIII-XIII of FIG. 12.

As shown in FIGS. 12 and 13, the communication module 21 may include a plurality of planar antennas 24. FIGS. 12 and 13 show an example of a case where the communication module 21 has nine planar antennas 24, each antenna group is configured by three planar antennas 24 which are coupled in one row, and the antenna groups are disposed so that their rows are parallel to each other.

In this case, in each of the antenna groups, the planar antenna 24 at each end is supported on the silicon wafer 23 by the axis member 25, and the planar antennas 24 are coupled to each other by conductive coupling members 36. The planar antennas 24 configuring one antenna group are coupled in one row by the coupling members 36 so that the antennas move in conjunction with each other while their planes are kept parallel to each other (the directions of the directionalities are always identical). The planar antennas 24 are configured so that the total area of the planes of all the planar antennas 24 is smaller than the opening area of the recess 31 of the silicon wafer 23.

In the communication module 21 of the embodiment, the small planar antenna 24 is operated highly accurately by the driving unit implemented as a MEMS device. Therefore, the direction of the directionality of the directional antenna can be controlled while the size of the communication module 21 is maintained to be small and thin. Consequently, also the size of the electronic apparatus 10 using the communication module 21 can be maintained to be small and thin. Also when the planar antenna 24 is implemented as a MEMS device, furthermore, the size of the communication module 21 can be made smaller and thinner.

The invention is not restricted to the embodiments as they are, and, in the stage of implementation, the invention can be embodied while the components are modified without departing the spirit and scope of the invention.

By appropriate combinations of plural components disclosed in the embodiments, various inventions can be configured. For example, some of the components may be omitted from all of the components shown in the embodiments.

For example, the electromagnetic wave which can be received by the planar antenna 24 is not restricted to a millimeter wave. When the planar antenna 24 receives an electromagnetic wave having a wavelength other than the millimeter wave band, the millimeter wave communication circuit is configured as a radio communication circuit corresponding to the wavelength of the electromagnetic wave which is received by the planar antenna 24.

When the communication module 21 has a plurality of planar antennas 24, the communication module 21 may configured so that the directions of the directionalities of the planar antennas 24 can be independently controlled.

The invention can be applied also to various electronic apparatuses having the radio communication function, in addition to the notebook personal computer which has been described in the embodiments. For example, the invention can be applied to a portable electronic apparatuses such as a portable game machine, a portable telephone, or a portable motion picture reproducing apparatus.

What is claimed is:

1. A communication module comprising:
a substrate comprising a recess, the recess comprising a bottom face and an aperture area;
a MEMS device comprising a directional antenna, the MEMS device disposed in the recess and comprising a planar portion; and
a supporting portion configured to support the MEMS device in such a manner that an angle between the planar portion and the bottom face is variable, the supporting portion configured to electrically connect the substrate to the directional antenna.

2. The communication module of claim 1, wherein an area of the planar portion is smaller than an aperture area of the recess.

3. The communication module of claim 2, further comprising a controller formed separately from the substrate, the controller configured to control the supporting portion and to control the angle.

4. The communication module of claim 3, wherein:
the controller is configured to apply a control power to the supporting portion; and
the supporting portion comprising a second MEMS device, the second MEMS device comprising an actuator driven according to the control power.

5. The communication module of claim 4, further comprising a casing configured to cover the substrate, the MEMS device, and the supporting portion,
wherein the casing comprises a plurality of external connecting terminals, each configured to electrically connect to a first portion of the substrate.

6. The communication module of claim 5, wherein the directional antenna is configured to receive a signal transmitted by a millimeter wave.

7. The communication module of claim 6, wherein:
the MEMS device comprises a plurality of MEMS devices that respectively comprise directional antennas and planar portions;
a plurality of couplers are configured to couple the plurality of MEMS devices in one row and to allow the directional antennas to move in conjunction with each other while the planar portions are kept parallel to each other;
the directional antennas are configured in such a manner that a total of areas of the planar portions is smaller than the aperture area of the recess; and
the supporting portion is configured to support the directional antennas in such a manner that the angle between the planar portions and the bottom face is variable.

8. The communication module of claim 7, wherein
the MEMS devices comprise a plurality of sets of MEMS devices, and
the plurality of sets of MEMS devices are respectively coupled in parallel rows, each supported by the supporting portion.

9. A communication module comprising:
a substrate;
a third MEMS device comprising a supporting portion, wherein a shape of the third MEMS device is variable;
a directional antenna held by the third MEMS device, the directional antenna comprising a planar portion;
a wire configured to electrically connect the directional antenna to the substrate; and
a controller formed separately from the substrate, the controller configured to control a change of the shape of the third MEMS device, wherein
the third MEMS device is configured to support the directional antenna in such a manner that an angle between the planar portion and a face of the substrate is variable in accordance with the change of the shape.

10. An electronic apparatus comprising:
a substrate comprising a recess, the recess comprising a bottom face and an aperture area;
a MEMS device comprising a directional antenna, the MEMS device disposed in the recess and comprising a planar portion; and
a supporting portion configured to support the MEMS device in such a manner that an angle between the planar portion and the bottom face is variable, the supporting portion configured to electrically connect the substrate to the directional antenna.

11. The apparatus of claim 10, further comprises a controller formed separately from the substrate, the controller configured to control the supporting portion and to control the angle.
